(19) United States
(12) Patent Application Publication
(10) Pub. No.: US 2015/0254640 A1
(43) Pub. Date: Sep. 10, 2015

(54) METHOD AND APPARATUS FOR DIGITAL CURRENCY PAPER WALLET

(71) Applicant: Cryptographi, Inc., San Francisco, CA (US)

(72) Inventors: Christopher Vincent Cassano, San Francisco, CA (US); Jered Kenna, San Francisco, CA (US)

(21) Appl. No.: 14/640,003

(22) Filed: Mar. 5, 2015

Related U.S. Application Data
(60) Provisional application No. 61/948,460, filed on Mar. 5, 2014.

(51) Int. Cl. G06Q 20/36; G06Q 20/20; G06Q 20/38

(52) U.S. Cl. CPC G06Q 20/36; G06Q 20/3829; G06Q 20/20

(57) ABSTRACT

Technology is disclosed for a standalone digital currency wallet generator for improved security. The digital currency wallet generator includes a print button, a processor and an internal printer. The print button generates a print signal in response to a user activating the print button. The processor generates a private key and a public key in response to the print signal, without any input signal received outside of the digital currency wallet generator. The private key and the public key form a digital currency wallet. The internal printer prints out a paper wallet. The paper wallet including information of the public key and the private key.

### CROSS-REFERENCE TO RELATED APPLICATION

This application claims the benefit of U.S. Provisional Patent Application No. 61/948,460, entitled “Method and Apparatus for Digital Currency Paper Wallet” and filed on Mar. 5, 2014, which is incorporated by reference herein in its entirety. This application relates to U.S. Design patent application Ser. No. 29/484,063, entitled “Digital Currency Wallet Generator” and filed on Mar. 5, 2014, and now issued as U.S. Design Pat. No. D721,130, which is incorporated by reference herein in its entirety.

### BACKGROUND

Digital currencies, e.g. bitcoin, litecoin, or Ripple, use cryptography to create and transfer money. A wallet for a digital currency can have a pair of cryptographic keys, including a public key and a private key. A digital currency transaction transfers an ownership of money in a digital currency denomination to an receiving address. The address can be represented by, e.g., the public key or an encoded form of the public key. The private key serves as a safeguard for the owner of the money. A valid payment message can include the public key and a digital signature derived from the private key.

Using the private key, anyone can transfer the digital currency money from the corresponding address to other addresses. If an unauthorized person has access to the private key, the person can spend the money stored in a virtual digital currency wallet represented by the corresponding address. The transactions are irreversible under the digital currency scheme. Thus, it is important to keep the private key safe.

### BRIEF DESCRIPTION OF THE DRAWINGS

One or more embodiments of the present invention are illustrated by way of example and not limitation in the figures of the accompanying drawings, in which like references indicate similar elements.

FIG. 1 illustrates an environment in which a digital currency wallet technology can be implemented.

FIG. 2 illustrates an embodiment of a digital currency wallet generator.

FIG. 3 illustrates an environment in which a digital currency wallet generator can be used as a point-of-sale (POS) system.

FIG. 4 illustrates an environment in which a point-of-sale (POS) system includes a digital currency wallet generator.

FIG. 5 illustrates an environment in which a digital currency wallet generator can be used in association with an ATM (automated teller machine) system.

FIG. 6 is a high-level block diagram showing an example of a processing device 600 that can represent any of the devices described above.

### DETAILED DESCRIPTION

References in this description to “an embodiment”, “one embodiment”, or the like, mean that the particular feature, function, structure or characteristic being described is included in at least one embodiment of the present invention. Occurrences of such phrases in this specification do not necessarily all refer to the same embodiment. On the other hand, the embodiments referred to also are not necessarily mutually exclusive.

Introduced here is a technique that enables generating a digital currency wallet with a public key and a private key without the need of connecting to any external device or system. Such a digital currency wallet generator can output the keys using, e.g., an internal printer. Since the digital currency wallet generator does not need to connect to a network or the Internet, the digital currency wallet generator ensures the security of the private key of the digital wallet.

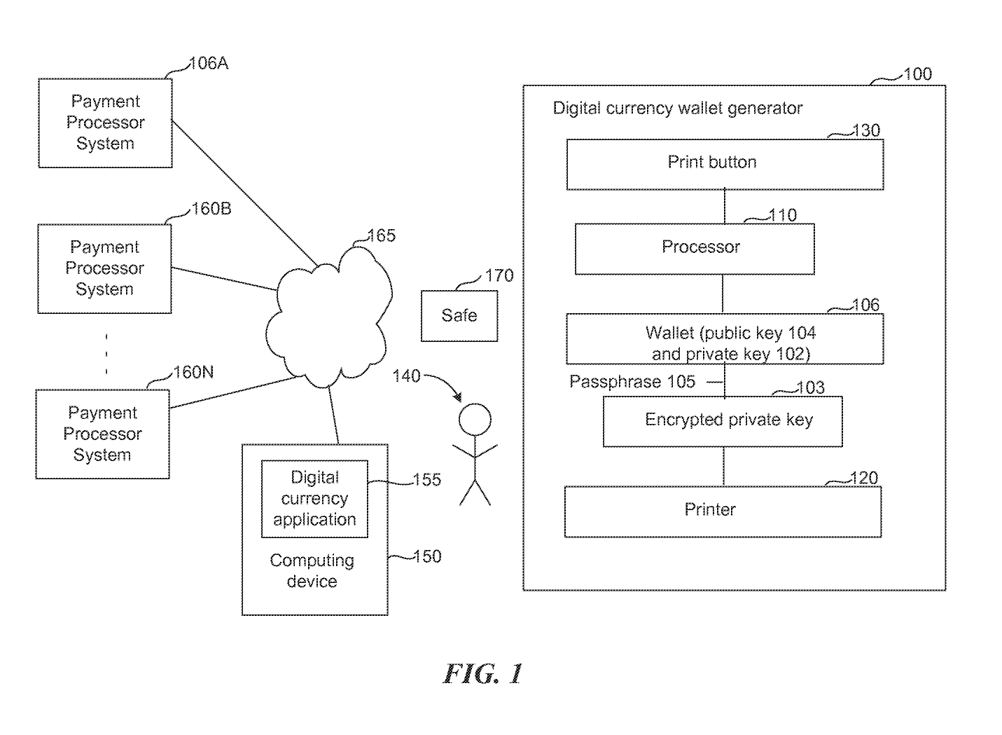

FIG. 1 illustrates an environment in which a digital currency wallet technology can be implemented. The environment includes a digital currency wallet generator 100. The digital currency wallet generator 100 includes a processor 110, a printer 120, and a print button 130. Using a hardware-based or software-based random number generator, the processor 110 can generate a private key 102. For instance, the processor 110 may generate a 256-bit number as a private key for a bitcoin wallet. Using a pre-determined one-way function, the processor 110 can further generate a corresponding public key 104 based on the private key 102. The pre-determined function is one-way so that the private key 102 cannot be generated or decrypted from the function by using the public key 104 as input. The public key 104 and the private key 102 form a digital currency wallet 106.

A user 140 of the digital currency wallet generator 100 can print out the digital currency wallet 106 by pressing the print button 130 on the generator 100. Upon receiving the signal from the print button 130, the processor 110 sends information of the public key 104 and the private key 102 to the printer 120. The printer 120 prints out a paper wallet 108 including the information of the public key 104 and the private key 102.

The paper wallet 108 can present the public key 104 and the private key 102 in various forms. For example, the paper wallet 108 can present the private key 102 as a 256-bit number or a character string. The character string can include 51 characters that include error checking information, or even have a mini private key format with as few as 30 characters. The paper wallet 108 can even present the private key as a one-dimensional barcode, or a two-dimensional barcode (e.g., a QR code). Similarly, the paper wallet 108 can present the public key 104 as a number, a character string, a one-dimensional or two-dimensional barcode, or a combination thereof.

The processor 110 may further encrypt the public key 104 or the private key 102 before sending them for printing. For instance, the processor 100 can encrypt the private key 102 through an encryption algorithm (e.g., BIP0038) using a passphrase 105 to generate an encrypted private key 103. The passphrase may be a preset of the user 140 or the processor 110.

Then the processor 110 instructs the printer 120 to print out the public key 104 and the encrypted private key 103. Optionally, the processor 110 can further instruct the printer 120 to print out the passphrase 105. Without the passphrase 105, other parties cannot access the actual private key 102 even if they can access the encrypted private key 103. Therefore, such parties cannot spend or initiate transactions from the digital currency wallet 106.

The generator 100 may present the passphrase to a user in various ways, if the user forgot the passphrase. For example, the generator 100 may print out the passphrase using the printer 120. Alternatively, the generator 100 may send the passphrase to the user in an email or a network message through a network port. The generator 100 may present the passphrase on a display device through a display port.

The user 140 receives the paper wallet 108 from the digital currency wallet generator 100. The user 140 can disclose the public key 104 or an encoded version of the public key 104 as an address to other parties for receiving digital currency money. For instance, the user 140 can disclose the public key 104 to a buyer, and the buyer can transfer digital currency money to the address of the public key 104.

The user 140 (or other persons) can use a computing device 150 to transfer money in the digital currency to the digital currency wallet 106 from another digital currency wallet. The computing device 150 can be, for example, a smart phone, tablet computer, notebook computer, or any other form of processing device. A digital currency application 155 runs on the computing device 150. Through the digital currency application 155, the user 140 can enter the public key 104 as the receiving wallet address and another pair of public and private keys as the sending wallet.

The computing device 150 sends the transaction information, including the receiving wallet address and the sending wallet, to at least one computing device of a peer-to-peer payment system. The computing device 150 and the computing devices 160A-160N of the peer-to-peer payment system are interconnected through an internetwork 165, which can be or include the Internet and one or more wireless networks (e.g., a WiFi network and or a cellular telecommunications network). The peer-to-peer payment system verifies the transaction and records the transaction in a public ledger. The peer-to-peer payment system may further send a confirmation to the computing device 150 indicating that the transaction is finished.

As far as the private key 104 is not lost or accessible by parties other than the user 140, the money in the digital wallet 106 is safe. The user 140 may choose to keep the paper wallet 108 in a secured place, such as a safe 170.

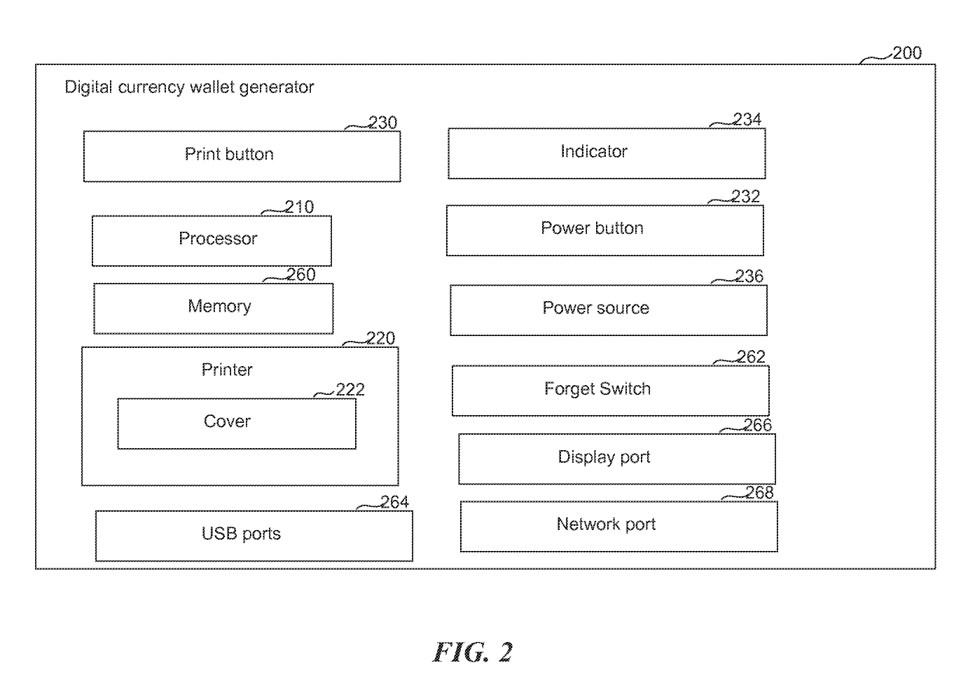

FIG. 2 illustrates an embodiment of a digital currency wallet generator. The digital currency wallet generator 200 includes a processor 210, a printer 220, a print button 230, a power button 232, an indicator 234, and power source 236. A user can press the power button 232 to turn on or to turn off the digital currency wallet generator 200. The processor 210 is responsible for generating a pair of public and private keys. When the user presses the print button 230, the printer 220 prints presentations of the public key and the private key on a paper as a paper wallet. In some alternative embodiments, the printer 220 may print a presentation of only one of the public and private keys on a paper. The generator 200 may include a cover 222. A user can open the cover 222 to replace or add papers for the printer 220. The printer 220 can be thermal printer.

The power source 236 can be a power supply to convert the alternating current to direct current in order to power the digital currency wallet generator 200. Alternatively, the generator 200 may include different types of power sources, such as battery or solar panel. The generator 200 may include multiple different power sources, and use one of the power sources as main power supply and others as backup power supply.

The indicator 234 may include a light-emitting diode (LED). The indicator 234 may use the light emitted from the LED and/or the color of the light to indicate different status of the generator 200. For instance, the indicator 234 may emit no light when the generator 200 is turned off. The indicator 234 may be slowly pulsing when the generator 200 is turned on. When the printer 220 is printing a paper wallet, the indicator 234 may flash.

The generator 200 may further include one or more memory 260 for executing applications on the generator 200 and/or storing data. The memory 260 can include, e.g., RAM, SD card, flash drive, hard drive, or a combination thereof.

The generator 200 can include a forget switch 262. When the forget switch 262 is switched to a “remember” side, the generator 200 stores the pairs of public and private keys (i.e., wallets) in the memory 260. When the forget switch 262 is switched to a “forget” side, the generator 200 does not store any information regarding the pairs of keys after the printer 220 prints the corresponding paper wallet.

The generator 200 may further include various types of ports to communicate with external devices and computers. The generator 200 may include one or more USB ports 264 (or other types of communication ports). A user can insert a USB drive into one of the USB ports 264 for various reasons. For example, the user may insert the USB drive to the generator 200 so that the generator 200 can further store a copy of a public/private key pair to the USB drive in addition to printing a paper wallet.

For example, the generator 200 can detect the inserted USB drive and tries to find the mount point of the USB drive. Once the generator 200 finds the mount point, the generator 200 copies the key pairs that are generated and stored internally in the “remember” mode to the USB drive. Different formats of the key pairs can be written to the USB drive, such text files and key database files. The generator 200 then unmounts the USB drive so that the user can remove the USB drive from the generator 200 safely without the risk of data corruption.

Alternatively, the generator 200 may read an existing pair of public/private keys stored in the USB drive, and print out the pair as a paper wallet. The USB drive may also contain a firmware upgrade for the generator 200. The generator 200 reads the firmware upgrade and updates the operating system and/or programs stored in the generator 200.

Input devices, e.g., keyboards or mice, can be inserted to the USB ports 264. The generator 200 recognizes these input devices and receives user inputs from the input devices similar to a regular computer.

The generator 200 may include a display port 266, such as an HDMI port. A user can connect a display device, e.g., a computer monitor or a television, to the display port. The generator 200 can present graphical user interface via the display port 266 on the display device. For instance, the generator 200 may display the generated public key and private key on the display device. For example, the generator 200 may detect a connected display device though the display port 266 and enters a display mode. During the display mode, the generator can receive user inputs from, e.g., keyboard or mouse through the USB ports 264. In the display mode, the generator 200 may require the user to enter a username and a password in order to user the generator 200 in display mode.

The generator 200 may also include a network port 268, such as an Ethernet port. The generator 200 may achieve various functionalities using the network port 268. The generator 200 may connect to the Internet through the network port 268 to download a newest firmware upgrade. The generator 200 then reads the firmware upgrade and updates the operating system and/or programs stored in the generator 200. Alternatively, or additionally, the generator 200 may automatically send the generated key pair to a remote device. For example, the generator 200 may send the generated key pair in order to store the digital currency wallet in an online storage or account of the user. The generator 200 may send the generated key pair in order to send or receive digital currency money through a transaction confirmed by the peer-to-peer payment system.

The generator 200 may use a USB printer or a network printer to print out the key pairs (paper wallets). For example, the generator 200 can enter the display mode by connecting to the display device through the display port 266. The user can click an icon displayed on the user interface to enter an interface for setting up printers. Then a printer management interface will be displayed. The user clicks a “add printer” button on the interface to add a printer, and follows the steps in the subsequent wizard interface to finish adding the USB or network printer. After the setup, the generator 200 can communicate with the USB or network printer to print out the key pairs. In some embodiments, the generator 200 does not include a printer and relies on an external printer to print out the key pairs.

In the display mode, the user can further retrieve the wallets from a remote server and print out the key pairs of the wallets. The user clicks on an icon for the retrieve mode. The user further clicks on a “receive” tab, clicks on a digital currency address and selects the option of “print.”

A user may use the generator 200 in a headless mode, e.g. without connecting to any external computing device. The user opens the cover 222 and inserts a roll of paper to the printer 220. Then the user hooks up the power source 236 and presses the power button 232. After a boot-up process, the digital currency wallet generator 200 is ready. The indicator 234 slowly pulses indicating that the generator 200 is ready. The indicator 234 is solidly lit when the generator 200 is loading.

The user can choose between single print and double print. When a user presses down on the print button 230, the indicator 234 (e.g., a LED light around the print button 230) goes off to indicate that the generator 200 is in single print mode. If the user continues to hold the print button 230 for 2 seconds, the indicator 234 goes on to indicate that the generator 200 is in double print mode. If the user further continues to hold the print button 230 for 8 more seconds, the indicator 234 goes off again to indicate that the generator 200 is turned off.

In the single print mode, a user can press and release the print button 230 to print a single paper wallet, i.e., a single paper copy of a pair of public and private keys. If the generator is also in “remember” mode (i.e., the forget switch 262 on “remember” side), the indicator 234 immediately become solidly lit, indicating that the generator 200 is generating, printing, and storing the key pair. If the generator is in “forget” mode (i.e., the forget switch 262 on “forget” side), the indicator 234 blinks 3 times indicating that the generated key pair will not be stored in the generator 200.

The user can press and hold the print button 230 for two seconds until the indicator 234 comes back on to print two identical paper copies of the generated key pairs. Similarly, if the generator is in “remember” mode, the indicator 234 immediately become solidly lit, indicating that the generator 200 is generating, printing, and storing the key pair. If the generator is in “forget” mode, the indicator 234 blinks 6 times indicating that the generated key pair will not be stored in the generator 200. The generator 200 may pause for a time period (e.g., 30 seconds) between printing each paper copy of key pair to allow the printer 220 to cool.

The display mode of the generator 200 may provide a user option to choose between different types of digital currency. For example, the user may choose a bitcoin or a litecoin format. Accordingly, the generator 200 will generates and prints out key pairs in a bitcoin format or a litecoin format.

The generator 200 may further encrypt the public key or the private key. Through the user interfaces in the display mode, a user can choose among different encryption methods, such as BIP0038 or AES. The user can further input the paraphrase to be used for encrypting the public or private key.

The generator 200 may encrypt the private key into multiple encrypted keys. A party will need the information of these multiple encrypted keys to access the actual private key. Alternatively, the generator 200 may encrypt the private key into multiple encrypted keys with redundancy information. A party will need the information from at least two of these multiple encrypted keys to access the actual private key, but not all encrypted keys are needed to access the private key. The generator 200 can further generate a redundancy key. If one or more encrypted keys are lost or corrupted (e.g., due to failed storage drive or ineligible paper wallet), the redundancy key can be used to supply the lost or corrupted information so that the private key can still be recovered. The user can distribute the encrypted keys to multiple parties and store the encrypted keys at different places to ensure the safety of the private key.

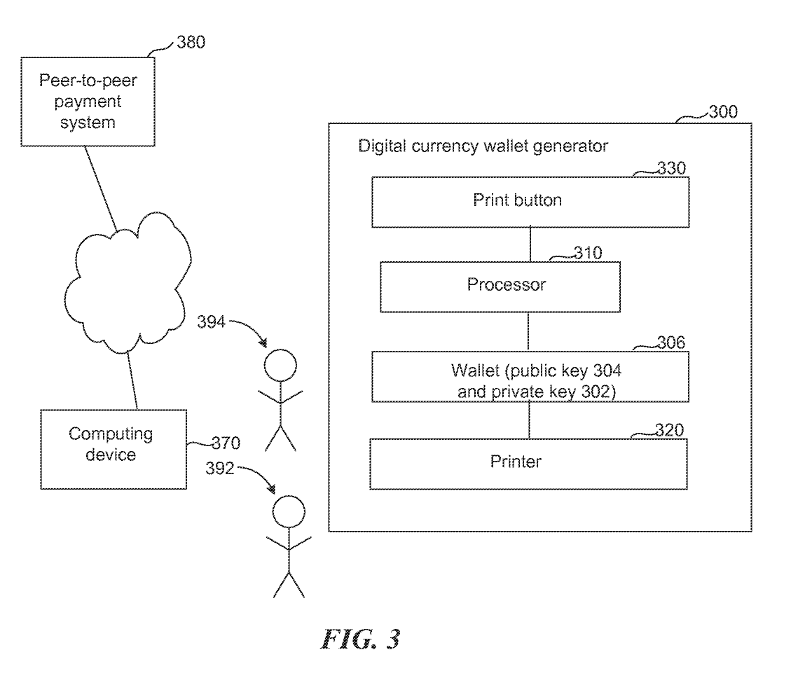

FIG. 3 illustrates an environment in which a digital currency wallet generator can be used as a point-of-sale (POS) system. A buyer 392 and a seller 394 want to conduct a payment transaction for a product, or a service provided by the seller 394 to the buyer 392. The seller 394 presses a print button 330 of a digital currency wallet generator 300. The generator 300 generates a pair of public and private keys 304 and 302 and prints out a paper wallet showing the key pair or only the public key. The seller 394 shows the public key 304 to the buyer 392.

The buyer 392 inputs the information of the public key 304 into a computing device 370. The buyer 392 may manually enter the public key 304 by using a keyboard or keypad connected to the computing device 370, or by scanning a one-dimensional or two-dimensional barcode using a camera or scanner connected to the computing device 370.

The buyer 392 further specifies a transaction amount and instructs the computing device 370 to initiate a payment transaction to transfer digital currency money from another wallet to the address of the public key 304. The public and private keys of the other wallet may be stored in the computing device 370, or entered by the buyer 392 to the computing device 370, or stored in a remove server.

The computing device 370 sends the payment transaction request along with the public key 304 to a digital currency peer-to-peer payment system 380. The peer-to-peer payment system 380 verifies the transaction and records the transaction in a public ledger. The peer-to-peer payment system 380 then sends a confirmation to the computing device 370 indicating that the transaction is finished. Accordingly, the computing device 370 presents a message on its display indicating that the money has been transferred to the address of the public key 304. The seller 394 can further confirm the transaction by himself by checking the balance and transaction history using the public key 304.

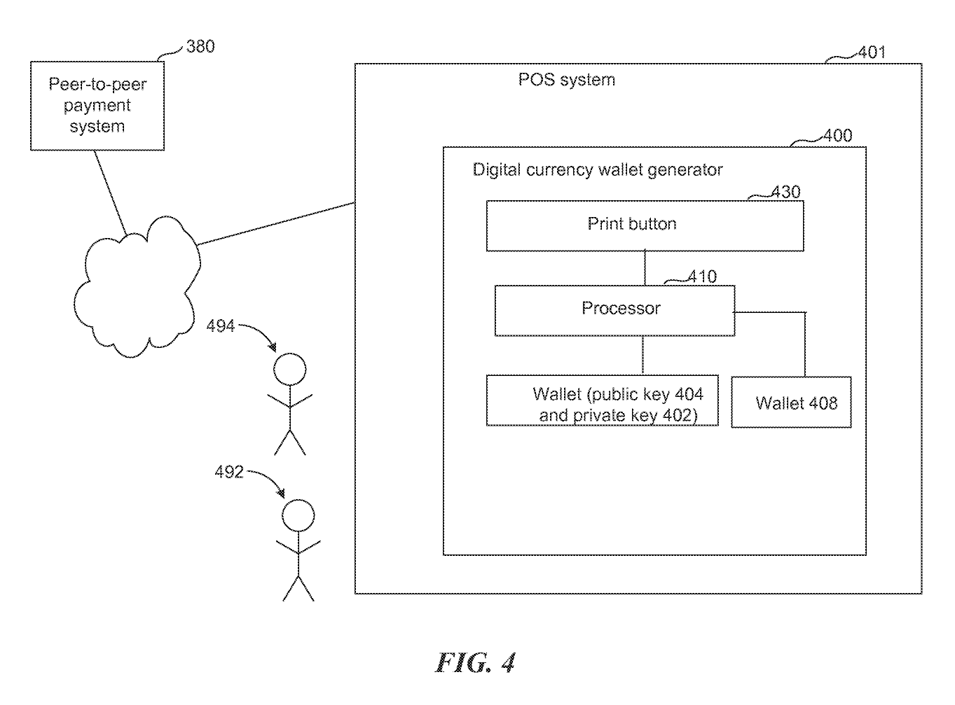

FIG. 4 illustrates an environment in which a point-of-sale (POS) system includes a digital currency wallet generator. A buyer 492 and a seller 494 want to conduct a payment transaction for a product, or a service provided by the seller 494 to the buyer 492. The seller 494 (or an agent of the seller 494) presses a button 430 of a POS system 401. The POS system 401 instructs a digital currency wallet generator 400 to generate a new key pair. The generator 400 generates a pair of public and private keys 404 and 402.

Optionally, the POS system 401 may present the public key 404, the private key 402, or both keys though an output component. The POS system 401 may print out a paper wallet showing the key pair or only one of the keys. The POS system 401 may show the public key 404 on a display of the POS system 401. The POS system 401 may send an email or a network message containing the key pair to a remove computing device.

The seller 394 may specify a transaction amount. The POS system 401 prompts the buyer 492 to enter information of a digital currency wallet from which the buyer 492 wants to pay. The information may include a public key and a private key of the wallet. Alternatively, the information may include only the private key, if the public key can be calculated from the private key using a pre-determined one-way function.

The buyer 492 inputs the information of his wallet 406 into the POS system 401. The POS system 401 can receive the inputs in various ways. The buyer 492 may manually enter the wallet information using a keyboard or keypad connected to the POS system 401, or scan one or more one-dimensional or two-dimensional barcodes using a camera or scanner connected to the POS system 401, or swipe a payment card through or a RFID device near a reader connected to the POS system 401.

The POS system 401 initiates a payment transaction to transfer a specified amount of digital currency money from the wallet of the buyer 492 to the address of the public key 404. The POS system 401 sends the payment transaction request with the public key 404 to a digital currency peer-to-peer payment system 480. The peer-to-peer payment system 480 verifies the transaction and records the transaction in a public ledger. The peer-to-peer payment system 480 then sends a confirmation to the POS system 401 indicating that the transaction is finished. Accordingly, the POS system 401 presents a message on its display indicating that the money has been transferred to the address of the public key 304.

The POS system 401 may further generate a new wallet 408 for the buyer 492 and transfer the buyer's remaining balance to the new wallet 408. The POS system 401 instructs the digital currency wallet generator 400 to generate the public key and the private key of the new wallet 408. The POS system 401 then requests a second transaction to transfer the remaining balance of the buyer's wallet 406 to the new wallet 408. Once the peer-to-peer payment system 480 confirms the transaction. The POS system 401 can present the information of the new wallet 408 and the balance to the buyer 492. For example, the POS system 401 can print a receipt that shows the public key and the private key of the new wallet 408 and the current balance of the new wallet 408. Alternatively, the POS system 401 may email or text-message the information of the new wallet 408 to the buyer 492

For security of the new wallet 408, the POS system 401 may choose to remove all information of the new wallet 408 so that only the buyer 492 has the access to the private key of the new wallet 408.

Alternatively, the generator 400 of the POS system 401 can encrypt the private key of the new wallet 408 using a passphrase chosen by the buyer 492. Then the POS system 401 prints out the encrypted private key on the receipt. Only the buyer 492 knows the passphrase. Even if the seller 494 and other parties can access the encrypted private key, they cannot access the actual private key because they do not know the passphrase for decrypting the key.

The POS system 401 can also automatically determine the passphrase for the buyer 492. The POS system 401 may email or text-message the passphrase to the buyer 492.

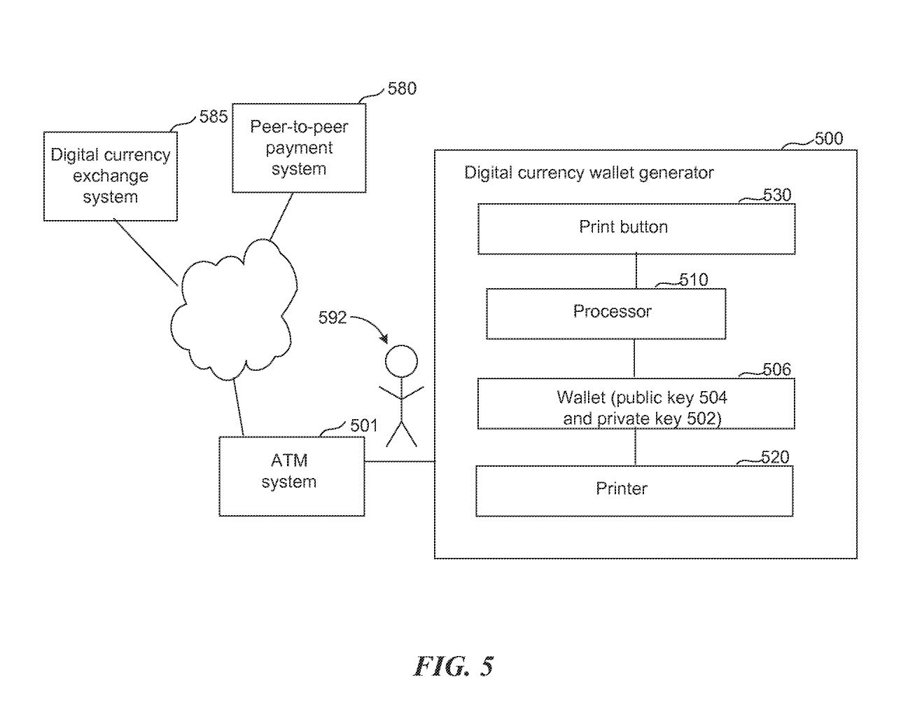

FIG. 5 illustrates an environment in which a digital currency wallet generator can be used in association with an ATM (automated teller machine) system. Using the digital currency wallet generator 500 and the ATM system 501, a customer can use cash to purchase balance of a digital currency wallet, or retrieve cash from a digital currency wallet.

If a customer 592 wants to use cash to purchase some balance of a digital currency wallet, the customer 592 presses a “new wallet” button 530 of the digital currency wallet generator 500. The generator 500 generates a pair of public and private keys 504 and 502, and transfers the public key 504 to the ATM system 501.

Alternatively, to ensure the digital currency wallet generator 500 is not connected to any external machine or device, the generator 500 prints out a paper wallet showing the key pair. The customer 592 then inputs the public key 504 into the ATM system 501 by using a keyboard or keypad, or by scanning a printed barcode.

The ATM system 501 receives the public key 504 and prompts the customer 592 to insert cash. Once the cash is inserted, the ATM system 501 confirms the cash amount with the customer 592. Then the ATM system 501 sends a purchase request to a digital currency exchange system 585 to purchase digital currency using the cash amount. The digital currency exchange system 585 transfers a balance of the digital currency money to the address of the public key 504.

Alternatively, the digital currency exchange system 585 sends a wallet address containing the balance of the digital currency money to ATM system 501. The ATM system 501 may then initiate another transaction with a digital currency peer-to-peer payment system 580 to transfer the digital currency balance to the address of the public key 504.

Once the ATM system 501 receives a confirmation of the balance. The ATM system 501 prints out a receipt showing the public key 504 and the current balance in the digital currency wallet associated with the public key 504.

If a customer 592 wants to transfer certain balance from an existing digital currency wallet to one or more new digital currency wallet, the customer 592 presses the “new wallet” button 530 of the digital currency wallet generator 500 once or multiple times. The generator 500 generates the pairs of public and private keys, and transfers the public keys to the ATM system 501. Alternatively, the generator 500 prints out the keys and the customer 592 inputs the key information to the ATM system 501.

The customer 592 further inputs the public and private keys of the existing digital currency wallet and specifies the transfer amount(s) to the ATM system 501.

The ATM system 501 then initiates one or more transactions with the digital currency peer-to-peer payment system 580 to transfer the specified digital currency balances to the addresses of the public keys of the new digital currency wallet. Once the ATM system 501 receives confirmations of the balances. The ATM system 501 prints out one or more receipts showing the public keys of the wallets and the current balances in the new digital current wallets. The receipt can also show the current balance of the original wallet of the customer 592. Using the generator 500 and ATM system 501, customer 592 can break down a digital wallet with multiple new wallets having smaller digital currency amounts.

The customer 592 can further retrieve cash from an existing digital currency wallet and keep the remaining digital currency balance in a new digital currency wallet. The customer 592 presses the “new wallet” button 530 of the digital currency wallet generator 500. The generator 500 generates a pair of public and private keys 504 and 502, and transfers the public key 504 to the ATM system 501.

Alternatively, the digital currency wallet generator 500 is not connected to any external machine or device. The generator 500 prints out a paper wallet showing the key pair. The customer 592 then inputs the public key 504 into the ATM system 501 by using a keyboard or keypad, or by scanning a barcode printed by the generator 500.

The customer 592 further specifies the amount of cash to be retrieved and inputs the information of the existing digital currency account by, e.g., typing on a keyboard or keypad, scanning barcode, inserting USB drive, specifying an online digital currency account, etc. Then the ATM system 501 sends a sell request to a digital currency exchange system 585 to sell digital currency using the cash amount. The digital currency exchange system 585 transfers a balance of the digital currency money to the address of the public key 504. Alternatively, the ATM system 501 can act as an exchange system to provide cash in exchange of the specified digital currency balance. The ATM system 501 may confirm the exchange rate with the customer 592 before conducting the currency exchange transaction.

The ATM system 501 provides the cash to the customer 592 and prints out a receipt showing the public key 504 and the current balance in the digital currency wallet associated with the public key 504. The receipt can further show the cash amount retrieved by the customer 592, the exchange rate, and/or the zero balance of the original digital currency wallet.

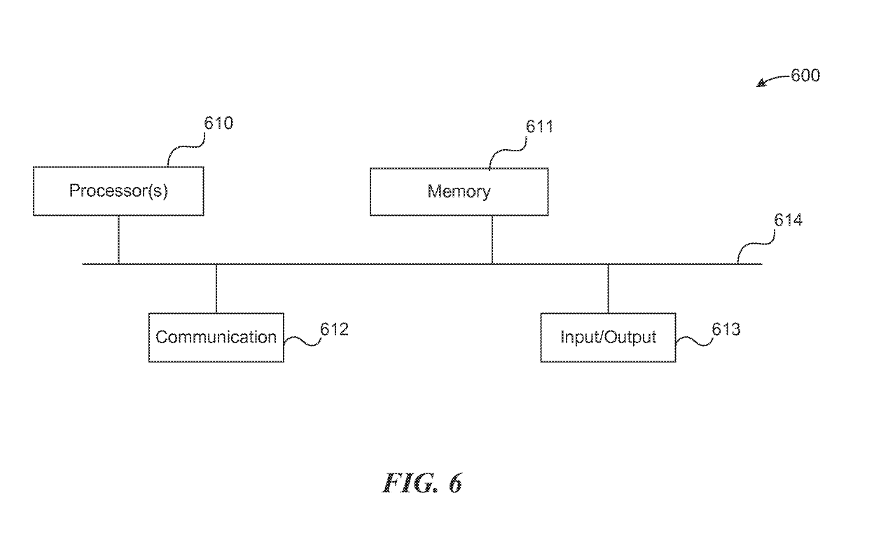

FIG. 6 is a high-level block diagram showing an example of a processing device 600 that can represent any of the devices described above. Any of these systems may be implemented using a computer conforming to the Raspberry Pi specification. As noted above, any of these systems may include two or more processing devices such as represented in FIG. 6, which may be coupled to each other via a network or multiple networks.

In the illustrated embodiment, the processing system 600 includes one or more processors 610, memory 611, a communication device 612, and one or more input/output (I/O) devices 613, all coupled to each other through an interconnect 614. The interconnect 614 may be or include one or more conductive traces, buses, point-to-point connections, controllers, adapters and/or other conventional connection devices. The processor(s) 610 may be or include, for example, one or more general-purpose programmable microprocessors, microcontrollers, application specific integrated circuits (ASICs), programmable gate arrays, or the like, or a combination of such devices. The processor(s) 610 control the overall operation of the processing device 600. Memory 611 may be or include one or more physical storage devices, which may be in the form of random access memory (RAM), read-only memory (ROM) (which may be erasable and programmable), flash memory, miniature hard disk drive, or other suitable type of storage device, or a combination of such devices. Memory 611 may store data and instructions that configure the processor(s) 610 to execute operations in accordance with the techniques described above. The communication device 612 may be or include, for example, an Ethernet adapter, cable modem, Wi-Fi adapter, cellular transceiver, Bluetooth transceiver, or the like, or a combination thereof. Depending on the specific nature and purpose of the processing device 600, the I/O devices 613 can include devices such as a display (which may be a touch screen display), audio speaker, keyboard, mouse or other pointing device, microphone, camera, etc.

Unless contrary to physical possibility, it is envisioned that (i) the methods/steps described above may be performed in any sequence and/or in any combination, and that (ii) the components of respective embodiments may be combined in any manner.

The techniques introduced above can be implemented by programmable circuitry programmed/configured by software and/or firmware, or entirely by special-purpose circuitry, or by a combination of such forms. Such special-purpose circuitry (if any) can be in the form of, for example, one or more application-specific integrated circuits (ASICs), programmable logic devices (PLDs), field-programmable gate arrays (FPGAs), etc.

Software or firmware to implement the techniques introduced here may be stored on a machine-readable storage medium and may be executed by one or more general-purpose or special-purpose programmable microprocessors. A “machine-readable medium”, as the term is used herein, includes any mechanism that can store information in a form accessible by a machine (a machine may be, for example, a computer, network device, cellular phone, personal digital assistant (PDA), manufacturing tool, any device with one or more processors, etc.). For example, a machine-accessible medium includes recordable/non-recordable media (e.g., read-only memory (ROM); random access memory (RAM); magnetic disk storage media; optical storage media; flash memory devices; etc.), etc.

Note that any and all of the embodiments described above can be combined with each other, except to the extent that it may be stated otherwise above or to the extent that any such embodiments might be mutually exclusive in function and/or structure.

Although the present invention has been described with reference to specific exemplary embodiments, it will be recognized that the invention is not limited to the embodiments described, but can be practiced with modification and alteration within the spirit and scope of the appended claims. Accordingly, the specification and drawings are to be regarded in an illustrative sense rather than a restrictive sense.

What is claimed is:

1. A digital currency wallet generator, comprising:
a print button configured to generate a print signal in response to a user activating the print button;
a processor configured to generate a private key and a public key in response to the print signal, the private key and the public key forming a digital currency wallet, wherein the processor generates the private key and the public key without any input signal received outside of the digital currency wallet generator; and
an internal printer configured to print a paper wallet, the paper wallet including information of the public key and the private key.

2. The digital currency wallet generator of claim 1, further comprising:
a forget switch configured to generate a forget signal instructing that the digital currency wallet generator does not store any information regarding the private key and the public key after the internal printer prints the paper wallet, in response to a user activating the forget switch.

3. The digital currency wallet generator of claim 2, further comprising:
an internal memory;
wherein the forget switch is further configured to generate a remember signal instructing that the digital currency wallet generator to store the private key and the public key in the internal memory, in response to a user switching the forget switch to a remember mode.

4. The digital currency wallet generator of claim 1, wherein the digital currency wallet generator operates in a headless mode in which the digital currency wallet generator produces the paper wallet without connecting to any external computing device.

5. The digital currency wallet generator of claim 1, wherein in response to the print button being pressed and released immediately, the internal printer is in a single print mode to print a single copy of the paper wallet presenting the private key and the public key.

6. The digital currency wallet generator of claim 1, wherein in response to the print button being pressed and hold for at least two seconds, the internal printer is in a double print mode to print two copies of the paper wallet, each copy of the paper wallet presenting the private key and the public key.

7. The digital currency wallet generator of claim 1, further comprising:
an light indicator;
wherein the light indicator slowly pulses when the digital currency wallet generator is ready to operate after a boot-up process.

8. The digital currency wallet generator of claim 7, wherein the light indicator becomes solidly lit after the internal printer printing out the paper wallet to indicate that the digital currency wallet generator is in a remember mode, and the digital currency wallet generator in the remember mode stores the private key and the public key in an internal memory.

9. The digital currency wallet generator of claim 7, wherein the light indicator blinks after the internal printer printing out the paper wallet to indicate that the digital currency wallet generator is in a forget mode, and the digital currency wallet generator in the forget mode does not store any information regarding the private key and the public key in any component of the digital currency wallet generator after the internal printer prints the paper wallet.

10. The digital currency wallet generator of claim 1, wherein the paper wallet printed by the internal printer presents the public key as a number, a character string, a one-dimensional barcode, or a two-dimensional barcode, and the paper wallet printed by the internal printer presents the private key as a number, a character string, a one-dimensional barcode, or a two-dimensional barcode.

11. The digital currency wallet generator of claim 1, wherein the processor is further configured to encrypt the private key into an encrypted form using a passphrase, and the paper wallet presents an encrypted form of the private key.

12. The digital currency wallet generator of claim 11, wherein the internal printer is configured to print the paper wallet that presents the passphrase, or wherein a network port of the digital currency wallet generator sends out a message including the passphrase through a computer network.

13. The digital currency wallet generator of claim 1, wherein the processor is further configured to encrypt the private key into a plurality of different encrypted keys, and information of the private key can be recovered using information of the plurality of encrypted keys.

14. The digital currency wallet generator of claim 1, wherein at least one encrypted key of the plurality of different encrypted keys include redundancy information, such that information of the private key can be recovered using less than all of the plurality of different encrypted keys or that information of the private key can be recovered even when information of one of the plurality of different encrypted keys is lost or corrupted.

15. The digital currency wallet generator of claim 1, wherein the processor generates the public key based on the private key using a one-way function such that the private key cannot be generated or decrypted from the one-way function by using the public key as input of the one-way function.

16. A method for conducting a peer-to-peer payment using a digital currency wallet generator, the method comprising:
receiving a print signal by the digital currency wallet generator in response to a print button being pressed;
generating a pair of a public key and a private key by a processor of the digital currency wallet generator;
printing out a paper wallet showing the private key and the public key;
inputting information of the public key and a transaction amount into a computing device, the transaction amount corresponds to a cost of a product or a service;
transferring digital currency money of the transaction amount to a digital currency address associated with the public key; and
recording a digital currency transaction of the transaction amount to the digital currency address in a public ledger of a digital currency peer-to-peer payment system.

17. The method of claim 16, wherein the digital currency wallet generator operates in a headless mode in which the digital currency wallet generator produces the paper wallet without connecting to any external computing device.

18. The method of claim 16, further comprising:
sending digital currency money from the digital currency address associated with the public key to another digital currency address by confirming the private key with the digital currency peer-to-peer payment system.

19. A method for conducting a point-of-sale (POS) transaction using a digital currency wallet generator, the method comprising:
receiving a generate signal by a point-of-sale (POS) system including the digital currency wallet generator in response to a button being pressed;
generating a pair of a public key and a private key by a processor of the digital currency wallet generator;
presenting a seller digital currency wallet showing the public key though an output component of the POS system;
inputting a transaction amount and information of a buyer digital currency wallet into the POS system, the transaction amount corresponds to a cost of a product or a service;
transferring digital currency money of the transaction amount to a digital currency address associated with the public key of the seller digital currency wallet; and
recording a digital currency transaction of the transaction amount in a public ledger of a digital currency peer-to-peer payment system.

20. The method of claim 19, wherein the information of the buyer digital currency wallet includes a private key and a public key.

21. The method of claim 19, further comprising:
printing out a paper copy of the seller digital currency wallet showing the private key and the public key of the seller digital currency wallet and a current balance of the digital currency address associated with the public key of the seller digital currency wallet.

22. The method of claim 19, further comprising:
inputting a passphrase into the digital currency wallet generator; and
encrypting the private key using the passphrase by the processor of the digital currency wallet generator.

23. A method for conducting a digital currency transaction using an automated teller machine (ATM) system, the method comprising:
receiving a print signal by a digital currency wallet generator in response to a print button being pressed;
generating a pair of a public key and a private key by a processor of the digital currency wallet generator;
printing out a paper wallet showing the private key;
transferring the public key from the digital currency wallet generator to the ATM system;
receiving by the ATM system a signal indicating that cash of a physical currency is inserted into the ATM machine;
determining an exchange rate between a digital currency and the physical currency of the cash and a purchase amount of the digital currency based on the exchange rate and an amount of the cash;
sending a purchase request for a digital currency money of the purchase amount to a digital currency exchange system; and
receiving a confirmation from the digital currency exchange system that a digital currency money of the purchase amount has been transferred to a digital currency address associated with the public key.

24. The method of claim 23, further comprising:
printing out a paper receipt showing the public key and a current balance of the digital currency address associated with the public key.
